(19) United States
(12) Patent Application Publication
(10) Pub. No.: US 2014/0372524 A1
(43) Pub. Date: Dec. 18, 2014

(54) Proximity Operations for Electronic File Views

(71) Applicant: Microsoft Corporation, Redmond, WA (US)

(72) Inventors: Sherman C. Der, NewCastle, WA (US); Prashant A. Shirolkar, Kirkland, WA (US)

(21) Appl. No.: 13/918,043

(22) Filed: Jun. 14, 2013

(51) Int. Cl. H04L 29/08

(52) U.S. Cl. CPC H04L 67/10
USPC 709/204

(57) ABSTRACT

The sharing of a file view between a computing device and another computing device in proximity is provided. A communication session may be established with the other computing device, utilizing short range wireless communication, upon the other computing device being physically proximate to the computing device. During the communication session, access may be granted for sharing the file view with the other computing device. The file view may include a file currently being displayed on the computing device. Finally, the file view may be communicated to the other computing device during the communication session for display.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Current hardware technology and software in mobile computing devices enables users to share electronic documents or files with other computing devices in a number of ways. For example, mobile computing devices may be configured to allow users to share contact information, image files or text documents utilizing short range wireless communication such as BLUETOOTH wireless technology, Near Field Communication (“NFC”), Wi-Fi, and the like when they are in proximity to another compatible computing device. There may be instances, however, when users have a need to share information on a limited basis due to security or other concerns. For example, a user may wish to share a current “view” of an open electronic document displayed on his or her mobile computing device. As another example, a user may need to share non-restricted information in a file containing both restricted and non-restricted information or, alternatively, share relevant information in a file containing both relevant and irrelevant information. However, current proximity sharing is constrained to an “all or nothing” proposition such that an entire file or document must be either shared or not shared. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for sharing of a file view between a computing device and another computing device which is in proximity. A communication session may be established with the other computing device upon the other computing device being physically proximate to the computing device. During the communication session, access may be granted for sharing the file view with the other computing device. The file view may include a file currently being displayed on the computing device. The file view may then be communicated to the other computing device for display during the communication session.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for sharing a file view between a computing device in proximity with another computing device, in accordance with various embodiments;

FIG. 2 is a diagram illustrating sharing a file view between a computing device in proximity with another computing device, in accordance with an embodiment;

FIG. 3 is a diagram illustrating sharing a file view between a computing device in proximity with another computing device, in accordance with the embodiment of FIG. 2;

FIG. 4 is a diagram illustrating sharing a file view between a computing device in proximity with another computing device, in accordance with the embodiment of FIG. 2;

FIG. 5 is a diagram illustrating sharing a file view between a computing device in proximity with another computing device, in accordance with another embodiment;

FIG. 6 is a diagram illustrating sharing a file view between a computing device in proximity with another computing device, in accordance with the embodiment of FIG. 5;

FIG. 7 is a diagram illustrating sharing a file view between a computing device in proximity with another computing device, in accordance with the embodiment of FIG. 5;

FIG. 8 is a flow diagram illustrating a routine for sharing a file view between a computing device in proximity with another computing device, in accordance with an embodiment;

FIG. 9 is a flow diagram illustrating a routine for sharing a file view between a computing device in proximity with another computing device, in accordance with another embodiment;

FIG. 10 is a simplified block diagram of a computing device with which various embodiments may be practiced;

FIG. 11A is a simplified block diagram of a mobile computing device with which various embodiments may be practiced;

FIG. 11B is a simplified block diagram of a mobile computing device with which various embodiments may be practiced; and

FIG. 12 is a simplified block diagram of a distributed computing system in which various embodiments may be practiced.

### DETAILED DESCRIPTION

Embodiments are provided for sharing of a file view between a computing device and another computing device which is in proximity. A communication session may be established with the other computing device upon the other computing device being physically proximate to the computing device. During the communication session, access may be granted for sharing the file view with the other computing device. The file view may include a file currently being displayed on the computing device. The file view may then be communicated to the other computing device for display during the communication session.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

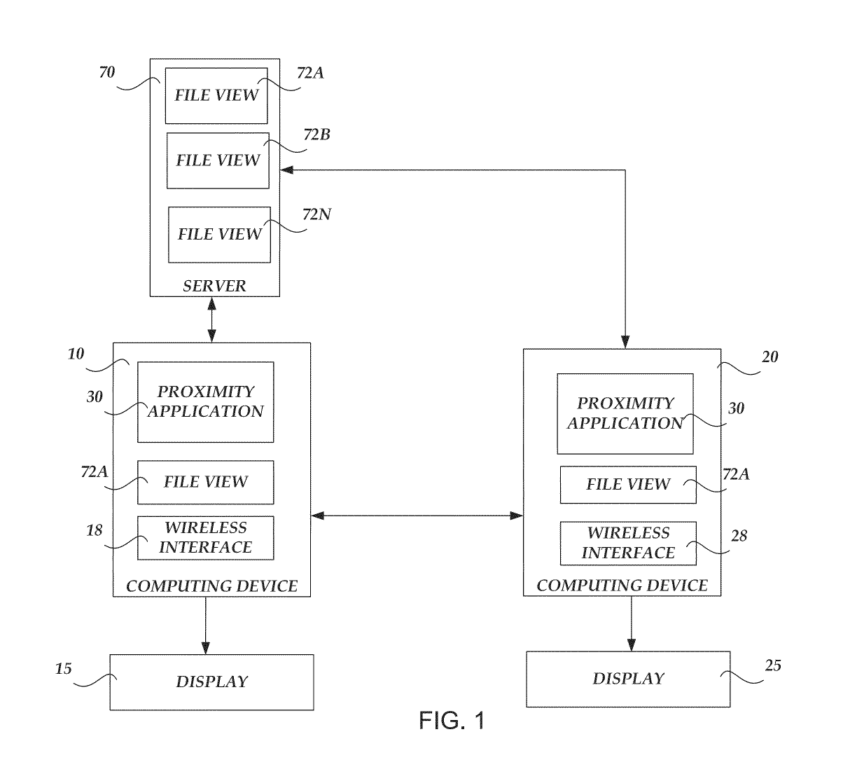

Referring now to the drawings, in which like numerals represent like elements through the several figures, various aspects of the present invention will be described. FIG. 1 is a block diagram illustrating a network architecture for sharing a file view between a computing device in proximity with another computing device, in accordance with various embodiments. The network architecture includes a computing device 10 which is in communication with a server 70 and another computing device 20. Each of the devices 10 and 20 is also in communication with displays 15 and 20 respectively. In accordance with an embodiment the computing devices 10 and 20 may each comprise a mobile computing device, such as a mobile telephone or smartphone, tablet or laptop computer, which is capable of short range wireless communication via wireless interfaces 18 and 28, respectively. It should be understood however, that the computing devices 10 and 20 are not limited to mobile computing devices and thus may also comprise other types of computing devices which are capable of short range wireless communication, without departing from the spirit and scope of the various embodiments described herein. For example, the computing device 10 may comprise a Near Field Communication (“NFC) enabled mobile telephone and the computing device 20 may comprise a nearby NFC enabled monitor.

In accordance with various embodiments, the wireless interfaces 18 and 28 may be configured to provide short range wireless communications via any of a number of technologies know to those skilled in the art including, but not limited to, BLUETOOTH wireless technology, NFC and Wi-Fi. The computing devices 10 and 20 may also each comprise a proximity application 30 and a file view 72A. In accordance with an embodiment and as will be described in greater detail below, the proximity application 30 may be configured to share file views with another computing device (e.g., the computing device 20) which is in proximity. For example, in accordance with an embodiment, the proximity application 30 may be configured to allow a user to prepare one or more file views selected from among the file views 72A-72N stored on the server 70 for sharing with other computing devices and discover when a computing device is in proximity (e.g., by using short range wireless communication). A “handshake” may then be performed between the proximate computing devices which may, in accordance with some embodiments, include a request received by a second computing device from a first computing device to join a communication session with the first computing device, an acceptance of the request by the second computing device and the granting of access to a file view by the first computing device for the second computing device.

As defined herein, a “file view” may include a copy of an electronic document previously created by a software application program which may be opened, viewed and printed on a computing device which does not have the corresponding software application program installed. For example, in accordance with an embodiment, the file views 72A-72N stored on the server 70 may comprise spreadsheet application file views of workbooks created by a spreadsheet application program. In accordance with an embodiment the proximity application 30 may comprise a “viewer” application for viewing spreadsheet application files (e.g., workbook files) such as the EXCEL VIEWER application from MICROSOFT CORPORATION of Redmond, Wash. In accordance with another embodiment, the proximity application 30 may comprise a web browser which may utilize a web application (not shown) stored on the server 70 to open spreadsheet application file views in a browser. An illustrative web application may include the EXCELL WEB APP application from MICROSOFT CORPORATION of Redmond Wash. It should be understood however, that the proximity application 30 may comprise other types of viewer applications (or alternatively be capable of utilizing other types of web applications) including, but not limited to, word processing applications, presentation applications and note-taking/collaboration applications. It should further be understood, however, that the embodiments described herein may also be practiced in conjunction with other application programs and further, is not limited to any particular application or system.

In accordance with an embodiment, the server 70 may comprise a file hosting service which may include the above-mentioned web applications. An illustrative file hosting service may include the SKYDRIVE file hosting service provided by MICROSOFT CORPORATION of Redmond, Wash. Other file hosting services may also be utilized.

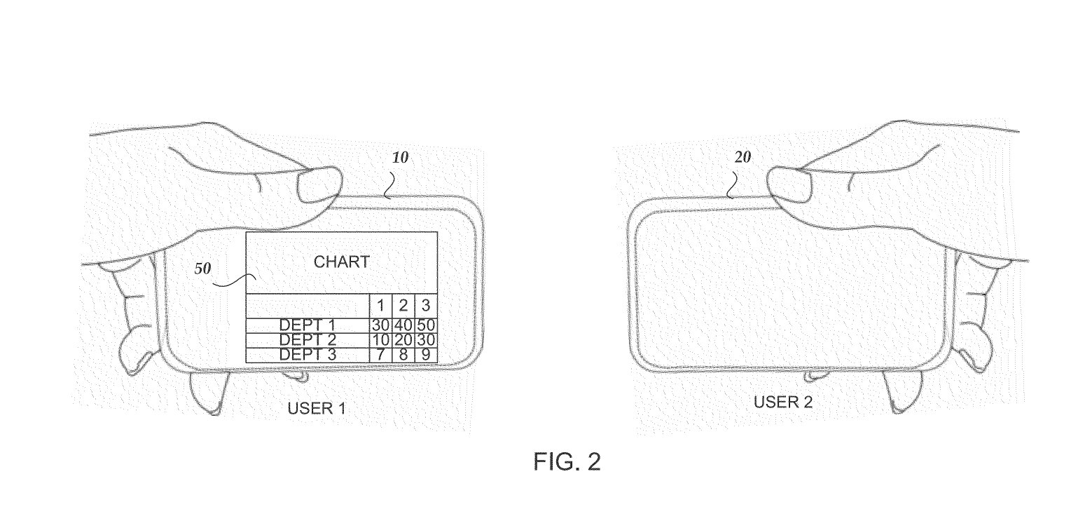

FIG. 2 is a diagram illustrating sharing a file view 50 between the computing device 10 and the computing device 20, in accordance with an embodiment. As shown in FIG. 2, a user of the computing device 10, which is currently displaying the file view 50 (shown as a spreadsheet), is preparing to establish a communication session so as to share the file view 50 with a user of the computing device 20.

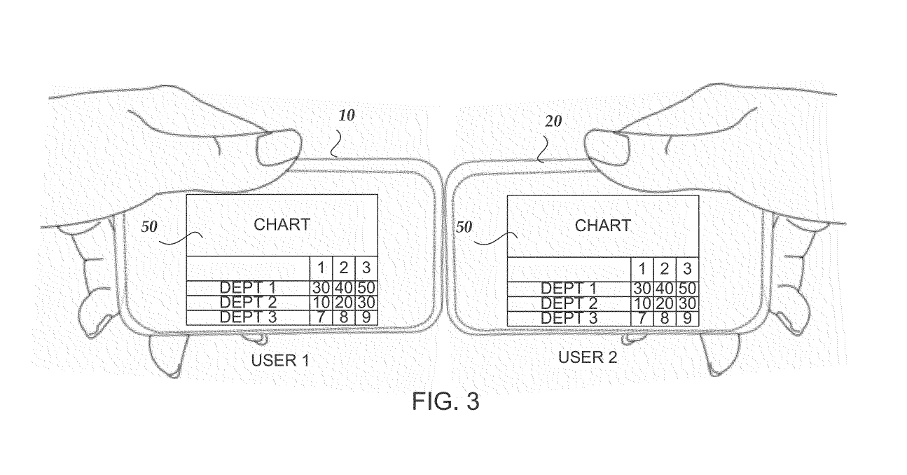

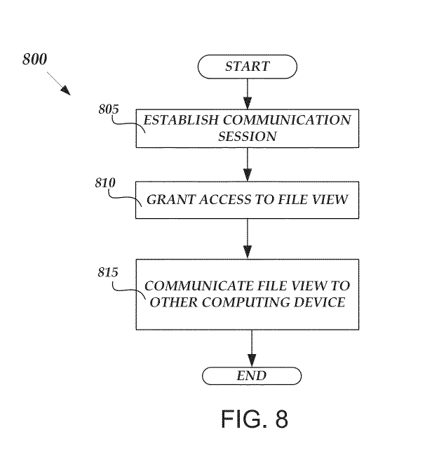

FIG. 3 is a diagram illustrating sharing a file view 50 between the computing device 10 and the computing device 20, in accordance with an embodiment. As shown in FIG. 3, the user of the computing device 10 shares the file view 50 by making physical contact with (i.e., tapping) the computing device 20. It should be understood that the tapping of the computing devices 10 and 20 may establish an NFC communication session resulting in the productivity application 30 executing on the computing device 10 granting access to the displayed file view 50. As will be discussed in greater detail below with respect to FIG. 8, the productivity application 30 may be configured such that the access granted to the file view 50 is temporary (i.e., the file view 50 may be viewed on the computing device 20 for a predetermined time period) or permanent.

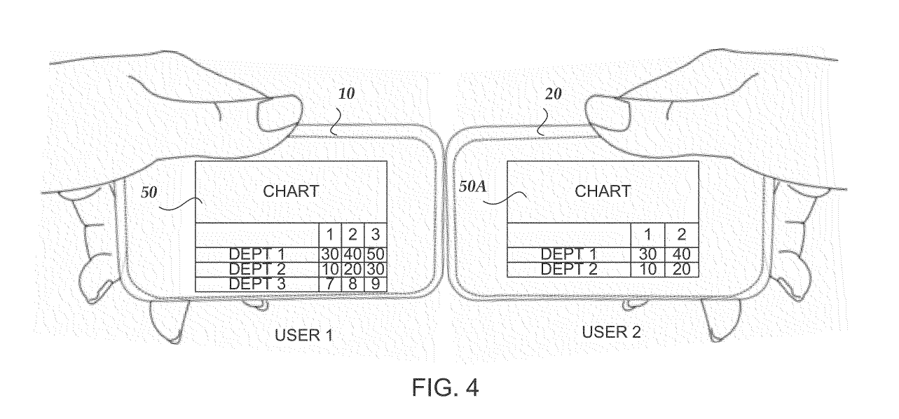

FIG. 4 is a diagram illustrating sharing a file view between the computing device 10 and the computing device 20, in accordance with an embodiment. As shown in FIG. 4, the user of the computing device 10 shares a portion of the file view 50 (i.e., file view 50A) by making physical contact with (i.e., tapping) the computing device 20. In accordance with this embodiment, and as will be discussed in greater detail below with respect to FIG. 8, the productivity application 30 may be configured such that the user of the computing device 10 may grant partial access to a displayed file view. For example, the productivity application 30 may allow a user to select specific rows and columns from a spreadsheet view to share with another user.

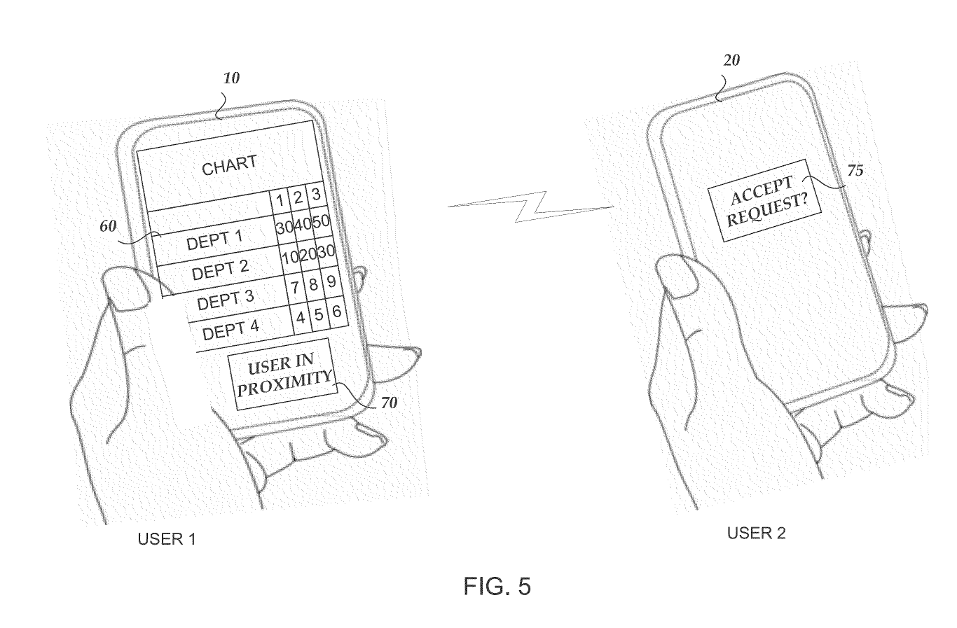

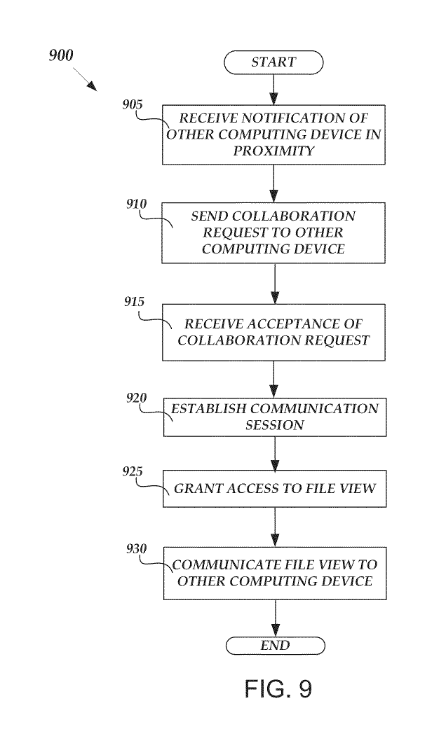

FIG. 5 is a diagram illustrating sharing a file view 60 between the computing device 10 and the computing device 20, in accordance with an embodiment. As shown in FIG. 5, a user of the computing device 10, which is currently displaying the file view 60 (shown as a spreadsheet), has received a notification 70 that a user is in proximity (i.e., the computing device 20). As will be described in greater detail below with respect to FIG. 9, after receiving the notification 70, the proximity application 30 may be configured to allow the user of the computing device 10 to send a request 75 (via short range wireless communication) to the computing device 20. The user of the computing device 20 may then accept the request 75 and, upon doing so, be granted access to the file view 60 displayed on the computing device 10.

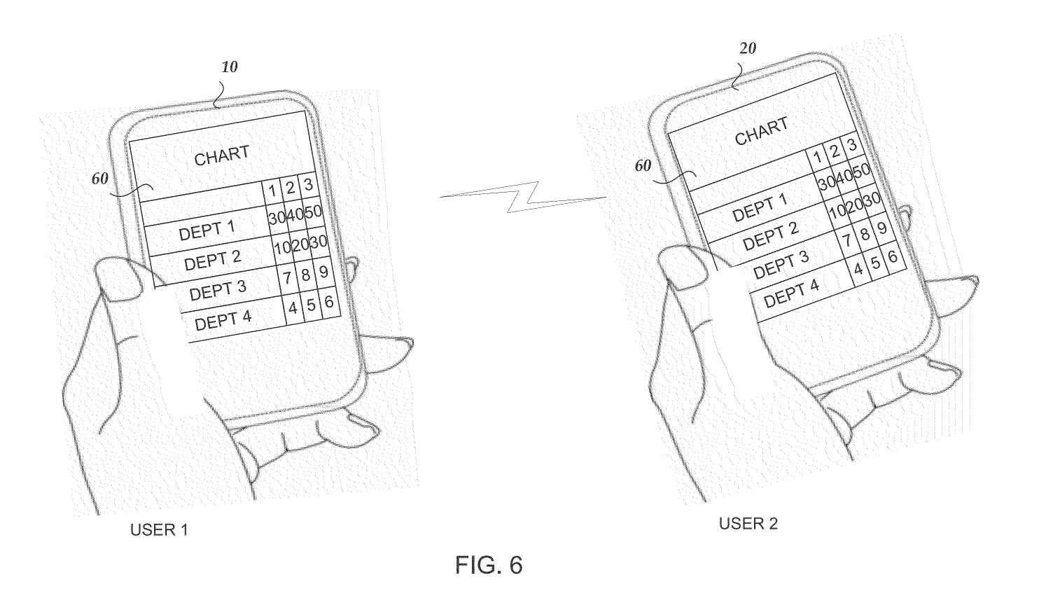

FIG. 6 is a diagram illustrating sharing a file view 60 between the computing device 10 and the computing device 20, in accordance with an embodiment. As shown in FIG. 6, the user of the computing device 10 shares the file view 60 via short range wireless communication (e.g., NFC, BLUETOOTH wireless technology, WiFi etc.) with the computing device 20. As will be discussed in greater detail below with respect to FIG. 9, the productivity application 30 may be configured such that the access granted to the file view 60 is temporary (i.e., the file view 60 may be viewed on the computing device 20 for a predetermined time period) or permanent.

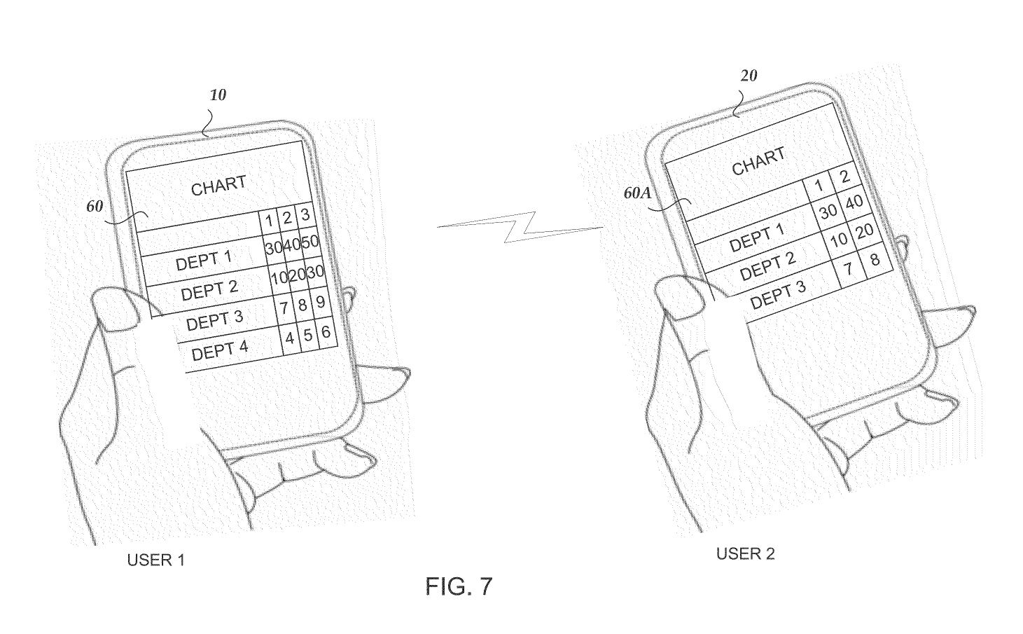

FIG. 7 is a diagram illustrating sharing a file view between the computing device 10 and the computing device 20, in accordance with an embodiment. As shown in FIG. 7, the user of the computing device 10 shares a portion of the file view 60 (i.e., file view 70A) via short range wireless communication (e.g., NFC, BLUETOOTH wireless technology, WiFi etc.) with the computing device 20. In accordance with this embodiment, and as will be discussed in greater detail below with respect to FIG. 9, the productivity application 30 may be configured such that the user of the computing device 10 may grant partial access to a displayed file view. For example, the productivity application 30 may allow a user to select specific rows and columns from a spreadsheet view to share with another user.

FIG. 8 is a flow diagram illustrating a routine 800 for sharing a file view between a computing device in proximity with another computing device, in accordance with an embodiment. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIGS. 8-9 and making up the various embodiments described herein are referred to variously as operations, structural devices, acts or modules. It will be recognized by one skilled in the art that these operations, structural devices, acts and modules may be implemented in software, in hardware, in firmware, in special purpose digital logic, and any combination thereof without deviating from the spirit and scope of the present invention as recited within the claims set forth herein.

The routine 800 begins at operation 805, where the proximity application 30, executing on the computing device 10, may establish a communication session with the computing device 20 upon the computing device 20 being in physical proximity. For example, a user having a file view (e.g., a spreadsheet or a web application session) open on the computing device 10 may physically tap or otherwise initiate short range wireless communication with the computing device 20 to establish the communication session.

From operation 805, the routine 800 continues to operation 810, where the proximity application 30, executing on the computing device 10, may grant access to a currently displayed file view. As discussed above, access to the file view on the computing device 10 may be controlled in a number of different ways. For example, temporary access may be granted so that the computing device 20 may only display the file view for a predetermined time period. As another example, partial access may be granted so that the computing device 20 may only have access to a subset of the file view (e.g., a predetermined range, a table or a chart making up a spreadsheet application file view).

From operation 810, the routine 800 continues to operation 815, where the productivity application 30, executing on the computing device 10, may communicate the file view for display on the computing device 20 during the communication session. From operation 815, the routine 800 then ends.

FIG. 9 is a flow diagram illustrating a routine 900 for sharing a file view between a computing device in proximity with another computing device, in accordance with another embodiment. The routine 900 begins at operation 905, where the proximity application 30, executing on the computing device 10, may receive a notification of the computing device 20 being in proximity. For example, a user of the computing device 10 having a spreadsheet file view (or spreadsheet web application session) open may be notified that another spreadsheet collaboration user (e.g., the computing device 20) is in close proximity and is available to participate or share or collaborate with their spreadsheet file view session. It should be understood that the user of the computing device 20 is not required to be known a priori to the user of the computing device 10.

From operation 905, the routine 900 continues to operation 910, where the productivity application 30, executing on the computing device 10, may send a collaboration request to the computing device 20. For example, upon a user of the computing device 10 being notified that the computing device 20 is in close proximity and is available to participate or share or collaborate with a spreadsheet file view session, the user, through the productivity application 30, may initiate a proximity spreadsheet file view collaboration request to the user of the computing device 20.

From operation 905, the routine 900 continues to operation 915, where the productivity application 30, executing on the computing device 10, may receive an acceptance of the collaboration request (which was sent at operation 910) from the computing device 20.

From operation 915, the routine 900 continues to operation 920, wherein the productivity application 30, executing on the computing device 10, may establish a communication session with the computing device 20. For example, a user having a file view (e.g., a spreadsheet or a web application session) open on the computing device 10 may physically tap or otherwise initiate short range wireless communication with the computing device 20 to establish the communication session.

From operation 920, the routine 900 continues to operation 925, where the proximity application 30, executing on the computing device 10, may grant access to a currently displayed file view. As discussed above, access to the file view on the computing device 10 may be controlled in a number of different ways. For example, temporary access may be granted so that the computing device 20 may only display the file view for a predetermined time period. As another example, partial access may be granted so that the computing device 20 may only have access to a subset of the file view (e.g., a predetermined range, a table or a chart making up a spreadsheet application file view).

From operation 925, the routine 900 continues to operation 930, where the productivity application 30, executing on the computing device 10, may communicate the file view for display on the computing device 20 during the communication session. From operation 915, the routine 900 then ends.

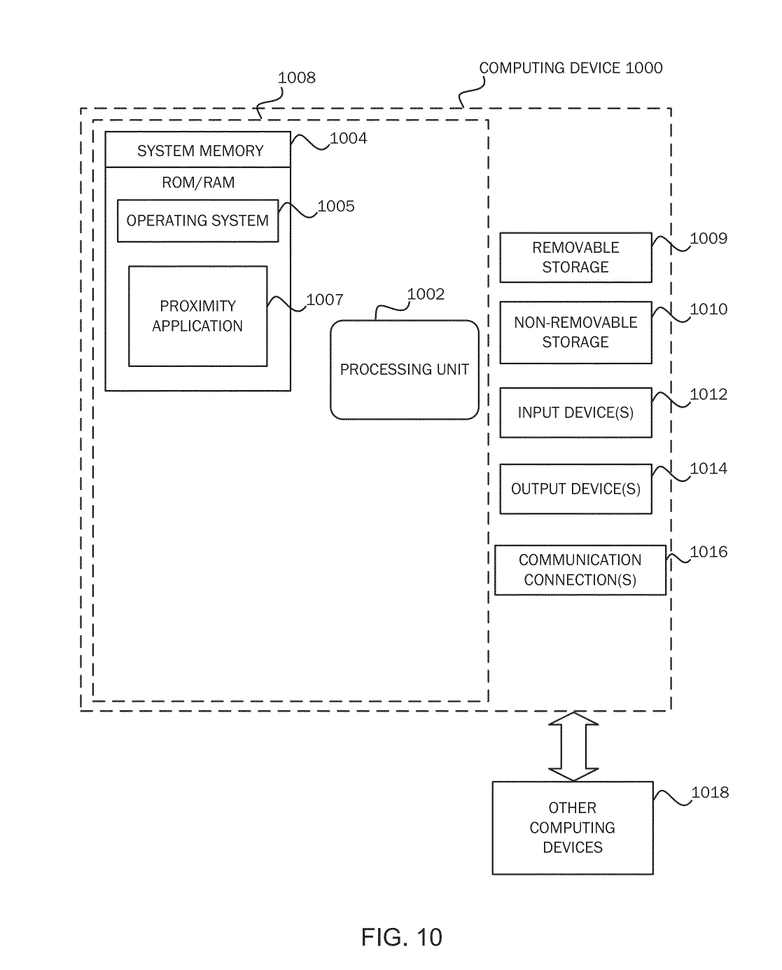

FIGS. 10-12 and the associated descriptions provide a discussion of a variety of operating environments in which embodiments of the invention may be practiced. However, the devices and systems illustrated and discussed with respect to FIGS. 10-12 are for purposes of example and illustration and are not limiting of a vast number of computing device configurations that may be utilized for practicing embodiments of the invention, described herein.

FIG. 10 is a block diagram illustrating example physical components of a computing device 1000 with which various embodiments may be practiced. In a basic configuration, the computing device 1000 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include an operating system 1005 and proximity application 1007. Operating system 1005, for example, may be suitable for controlling the computing device 1000′s operation and, in accordance with an embodiment, may comprise the WINDOWS operating systems from MICROSOFT CORPORATION of Redmond, Wash. The proximity application 1007, for example, may comprise functionality for performing routines including, for example, sharing a file view between a computing device in proximity with another computing device, as described above with respect to the operations in routines 800 and 900 of FIGS. 8-9. It should be understood, however, that the embodiments described herein may also be practiced in conjunction with other operating systems and application programs and further, is not limited to any particular application or system.

The computing device 1000 may have additional features or functionality. For example, the computing device 1000 may also include additional data storage devices (removable and/or non-removable) such as, for example, magnetic disks, optical disks, solid state storage devices (“SSD”), flash memory or tape. Such additional storage is illustrated in FIG. 10 by a removable storage 1009 and a non-removable storage 1010. The computing device 1000 may also have input device(s) 1012 such as a keyboard, a mouse, a pen, a sound input device (e.g., a microphone), a touch input device for receiving gestures, an accelerometer or rotational sensor, etc. Output device(s) 1014 such as a display, speakers, a printer, etc. may also be included. The aforementioned devices are examples and others may be used. The computing device 1000 may include one or more communication connections 1016 allowing communications with other computing devices 1018. Examples of suitable communication connections 1016 include, but are not limited to, RF transmitter, receiver, and/or transceiver circuitry; universal serial bus (USB), parallel, and/or serial ports.

Furthermore, various embodiments may be practiced in an electrical circuit comprising discrete electronic elements, packaged or integrated electronic chips containing logic gates, a circuit utilizing a microprocessor, or on a single chip containing electronic elements or microprocessors. For example, various embodiments may be practiced via a system-on-a-chip (“SOC”) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may operate via application-specific logic integrated with other components of the computing device/system 1000 on the single integrated circuit (chip). Embodiments may also be practiced using other technologies capable of performing logical operations such as, for example, AND, OR, and NOT, including but not limited to mechanical, optical, fluidic, and quantum technologies. In addition, embodiments may be practiced within a general purpose computer or in any other circuits or systems.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

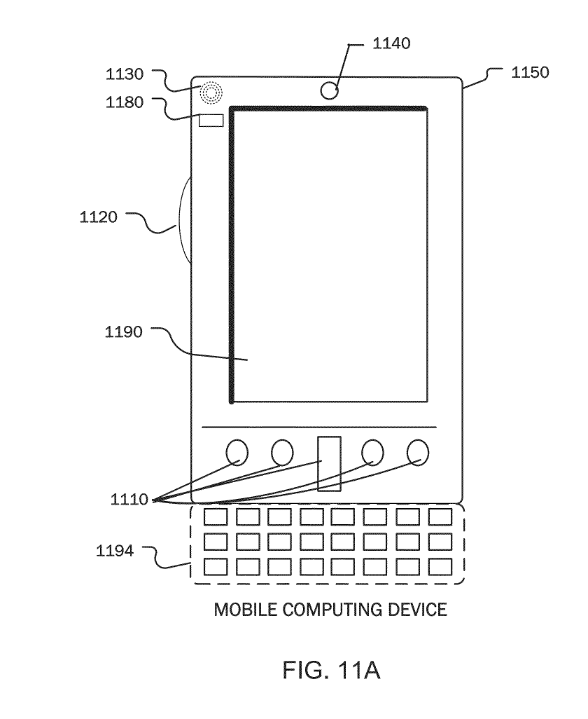

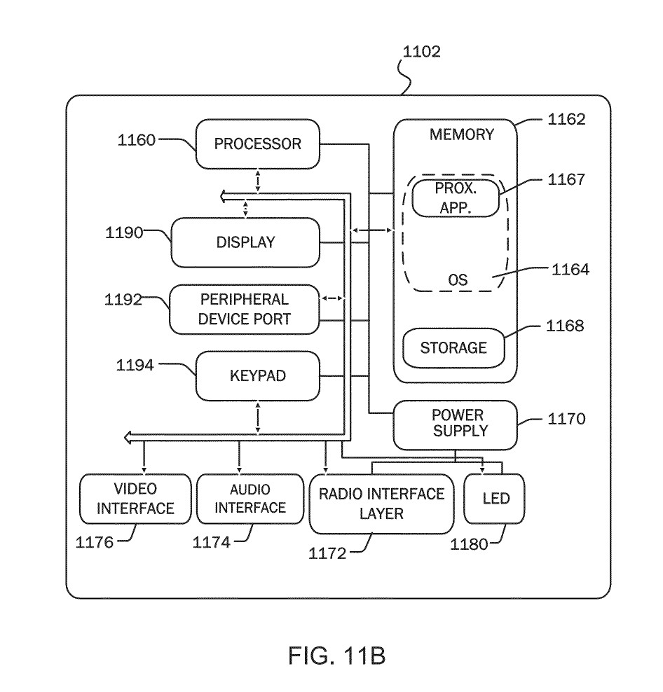

FIGS. 11A and 11B illustrate a suitable mobile computing environment, for example, a mobile computing device 1150 which may include, without limitation, a smartphone, a tablet personal computer, a laptop computer, and the like, with which various embodiments may be practiced. With reference to FIG. 11A, an example mobile computing device 1150 for implementing the embodiments is illustrated. In a basic configuration, mobile computing device 1150 is a handheld computer having both input elements and output elements. Input elements may include touch screen display 1125 and input buttons 1110 that allow the user to enter information into mobile computing device 1150. Mobile computing device 1150 may also incorporate an optional side input element 1120 allowing further user input. Optional side input element 1120 may be a rotary switch, a button, or any other type of manual input element. In alternative embodiments, mobile computing device 1150 may incorporate more or less input elements. In yet another alternative embodiment, the mobile computing device is a portable telephone system, such as a cellular phone having display 1125 and input buttons 1110. Mobile computing device 1150 may also include an optional keypad 1105. Optional keypad 1105 may be a physical keypad or a “soft” keypad generated on the touch screen display.

Mobile computing device 1150 incorporates output elements, such as display 1125, which can display a graphical user interface (GUI). Other output elements include speaker 1130 and LED 1180. Additionally, mobile computing device 1150 may incorporate a vibration module (not shown), which causes mobile computing device 1150 to vibrate to notify the user of an event. In yet another embodiment, mobile computing device 1150 may incorporate a headphone jack (not shown) for providing another means of providing output signals.

Although described herein in combination with mobile computing device 1150, in alternative embodiments may be used in combination with any number of computer systems, such as in desktop environments, laptop or notebook computer systems, multiprocessor systems, micro-processor based or programmable consumer electronics, network PCs, mini computers, main frame computers and the like. Various embodiments may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate the various embodiments described herein.

FIG. 11B is a block diagram illustrating components of a mobile computing device used in one embodiment, such as the mobile computing device 1150 shown in FIG. 11A. That is, mobile computing device 1150 can incorporate a system 1102 to implement some embodiments. For example, system 1102 can be used in implementing a “smartphone” that can run one or more applications similar to those of a desktop or notebook computer. In some embodiments, the system 1102 is integrated as a computing device, such as an integrated personal digital assistant (PDA) and wireless phone.

Proximity application 1167 may be loaded into memory 1162 and run on or in association with an operating system 1164. The system 1102 also includes non-volatile storage 1168 within memory the 1162. Non-volatile storage 1168 may be used to store persistent information that should not be lost if system 1102 is powered down. The proximity application 1167 may use and store information in the non-volatile storage 1168. The proximity application 1167 may also include functionality for performing routines including, for example, sharing a file view between a computing device in proximity with another computing device, as described above with respect to the operations in routines 800 and 900 of FIGS. 8-9. A synchronization application (not shown) also resides on system 1102 and is programmed to interact with a corresponding synchronization application resident on a host computer to keep the information stored in the non-volatile storage 1168 synchronized with corresponding information stored at the host computer. As should be appreciated, other applications may also be loaded into the memory 1162 and run on the mobile computing device 1150.

The system 1102 has a power supply 1170, which may be implemented as one or more batteries. The power supply 1170 might further include an external power source, such as an AC adapter or a powered docking cradle that supplements or recharges the batteries.

The system 1102 may also include a radio 1172 (i.e., radio interface layer) that performs the function of transmitting and receiving radio frequency communications. The radio 1172 facilitates wireless connectivity between the system 1102 and the “outside world,” via a communications carrier or service provider. Transmissions to and from the radio 1172 are conducted under control of OS 1164. In other words, communications received by the radio 1172 may be disseminated to the proximity application 1167 via OS 1164, and vice versa.

The radio 1172 allows the system 1102 to communicate with other computing devices, such as over a network. The radio 1172 is one example of communication media. The embodiment of the system 1102 is shown with two types of notification output devices: the LED 1180 that can be used to provide visual notifications and an audio interface 1174 that can be used with speaker 1130 to provide audio notifications. These devices may be directly coupled to the power supply 1170 so that when activated, they remain on for a duration dictated by the notification mechanism even though processor 1160 and other components might shut down for conserving battery power. The LED 1180 may be programmed to remain on indefinitely until the user takes action to indicate the powered-on status of the device. The audio interface 1174 is used to provide audible signals to and receive audible signals from the user. For example, in addition to being coupled to speaker 1130, the audio interface 1174 may also be coupled to a microphone (not shown) to receive audible (e.g., voice) input, such as to facilitate a telephone conversation. In accordance with embodiments, the microphone may also serve as an audio sensor to facilitate control of notifications. The system 1102 may further include a video interface 1176 that enables an operation of on-board camera 1140 to record still images, video streams, and the like.

A mobile computing device implementing the system 1102 may have additional features or functionality. For example, the device may also include additional data storage devices (removable and/or non-removable) such as, magnetic disks, optical disks, or tape. Such additional storage is illustrated in FIG. 11B by storage 1168.

Data/information generated or captured by the mobile computing device 1150 and stored via the system 1102 may be stored locally on the mobile computing device 1150, as described above, or the data may be stored on any number of storage media that may be accessed by the device via the radio 1172 or via a wired connection between the mobile computing device 1150 and a separate computing device associated with the mobile computing device 1150, for example, a server computer in a distributed computing network such as the Internet. As should be appreciated such data/information may be accessed via the mobile computing device 1150 via the radio 1172 or via a distributed computing network. Similarly, such data/information may be readily transferred between computing devices for storage and use according to well-known data/information transfer and storage means, including electronic mail and collaborative data/information sharing systems.

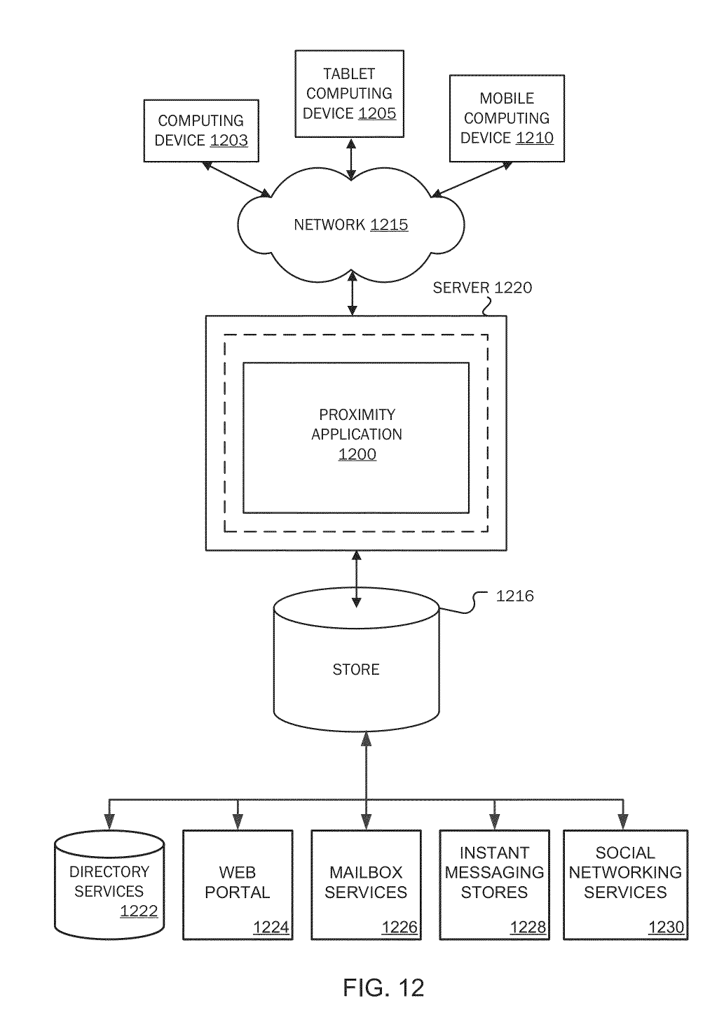

FIG. 12 is a simplified block diagram of a distributed computing system in which various embodiments may be practiced. The distributed computing system may include number of client devices such as a computing device 1203, a tablet computing device 1205 and a mobile computing device 1210. The client devices 1203, 1205 and 1210 may be in communication with a distributed computing network 1215 (e.g., the Internet). A server 1220 is in communication with the client devices 1203, 1205 and 1210 over the network 1215. The server 1220 may store proximity application 1200 which may be perform routines including, for example, sharing a file view between a computing device in proximity with another computing device, as described above with respect to the operations in routines 800-900 of FIGS. 8-9. Content developed, interacted with, or edited in association with the proximity application 1200 may be stored in different communication channels or other storage types. For example, various documents may be stored using a directory service 1222, a web portal 1224, a mailbox service 1226, an instant messaging store 1228, or a social networking site 1230.

The proximity application 1200 may use any of these types of systems or the like for enabling data utilization, as described herein. The server 1220 may provide the proximity application 1200 to clients. As one example, the server 1220 may be a web server providing the proximity application 1200 over the web. The server 1220 may provide the proximity application 1200 over the web to clients through the network 1215. By way of example, the computing device 10 may be implemented as the computing device 1203 and embodied in a personal computer, the tablet computing device 1205 and/or the mobile computing device 1210 (e.g., a smart phone). Any of these embodiments of the computing devices 1203, 1205 and 1210 may obtain content from the store 1216.

Various embodiments are described above with reference to block diagrams and/or operational illustrations of methods, systems, and computer program products. The functions/acts noted in the blocks may occur out of the order as shown in any flow diagram. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method of sharing a file view between a computing device in proximity with another computing device, comprising:
establishing a communication session with the another computing device upon the another computing device being physically proximate to the computing device;
granting access to the file view to the another computing device during the communication session, the file view comprising a file currently being displayed on the computing device; and
communicating the file view for display on the another computing device during the communication session.

2. The method of claim 1, wherein establishing a communication session with the another computing device upon the another computing device being physically proximate to the computing device comprises:
receiving a notification that the another computing device is physically proximate to the computing device;
sending a collaboration request to the another computing device; and
receiving an acceptance of the collaboration request from the another computing device.

3. The method of claim 1, wherein the communication session with the another computing device is established in response to physical contact between the computing device and the another computing device.

4. The method of claim 1, wherein granting access to the file view to the another computing device during the communication session comprises granting the access to the file view for a predetermined time period.

5. The method of claim 1, wherein granting access to the file view to the another computing device during the communication session comprises granting access to a spreadsheet application file view.

6. The method of claim 1, wherein granting access to the file view to the another computing device during the communication session comprises granting access to a subset of the file view.

7. The method of claim 6, wherein granting access to a subset of the file view comprises granting access to one or more of a predetermined range, a table and a chart in a spreadsheet application file view.

8. A computing device comprising:
a memory for storing executable program code; and
a processor, functionally coupled to the memory, the processor being responsive to computer-executable instructions contained in the program code and operative to:
establish a communication session with another computing device upon the another computing being physically proximate to the computing device;
grant access to a file view to the another computing device during the communication session, the file view comprising a currently displayed file on the computing device; and
share the file view with the another computing device for display during the communication session.

9. The computing device of claim 8, wherein the processor, in establishing a communication session with the another computing device, is operative to:
receive a notification that the another computing device is physically proximate to the computing device;
initiate sending a collaboration request to the another computing device; and
receive an acceptance of the collaboration request from the another computing device.

10. The computing device of claim 8, wherein the communication session with the another computing device is established in response to physical contact with the another computing device.

11. The computing device of claim 8, wherein the access to the file view is granted to the another computing device for a predetermined time period.

12. The computing device of claim 8, wherein the file view comprises a spreadsheet application file view.

13. The computing device of claim 8, wherein the processor, in granting access to the file view to the another computing device during the communication session, is operative to grant access to a subset of the file view.

14. The computing device of claim 8, wherein the subset of the file view comprises one or more of a predetermined range, a table and a chart in a spreadsheet application file view.

15. A computer-readable storage medium storing computer executable instructions which, when executed on a first computing device, will cause the first computing device to perform a method of sharing a file view with a second computing device, the method comprising:
receiving a proximity notification from the second computing device that the second computing device is physically proximate to the first computing device;
sending a collaboration request to the second computing device;
receiving an acceptance of the collaboration request from the second computing device;
establishing a communication session with the second computing device;
granting access to the file view to the second computing device during the communication session, the file view comprising a file currently being displayed on the first computing device; and
communicating the file view to the second computing device during the communication session.

16. The computer-readable storage medium of claim 15, wherein granting access to the file view to the second computing device during the communication session comprises granting the access to the file view for a predetermined time period.

17. The computer-readable storage medium of claim 15, wherein granting access to the file view to the second computing device during the communication session comprises granting access to a spreadsheet application file view.

18. The computer-readable storage medium of claim 15, wherein granting access to the file view to the second computing device during the communication session comprises granting access to a subset of the file view.

19. The computer-readable storage medium of claim 18, wherein the subset of the file view comprises predetermined range in a spreadsheet application file view.

20. The computer-readable storage medium of claim 18, wherein the subset of the file view comprises a predetermined chart in a spreadsheet application file view.
